(19) United States
(12) Patent Application Publication
(10) Pub. No.: US 2010/0088117 A1
(43) Pub. Date: Apr. 8, 2010

(54) Multi-Mode Medical Data Reporting System

(75) Inventors: Alvin Jackson Belden, Media, PA (US); Charles E. Edson, JR., Newton Square, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/571,617

(22) Filed: Oct. 1, 2009

Related U.S. Application Data
(60) Provisional application No. 61/102,200, filed on Oct. 2, 2008.

(51) Int. Cl. G06Q 50/00; G06F 17/30; G06F 3/048

(52) U.S. Cl. 705/3; 707/741; 715/738; 707/E17.005

(57) ABSTRACT

A multi-mode system and method for exchanging patient medical record information and data an order for a medical procedure for a patient between different medical information systems for producing medical report data is provided. The system comprises a repository including a first set of clinical data items employing a first set of codes, terms and identifiers associated with a plurality of different patients accessible by a parent medical information system application. A user interface initiates generation of data representing at least one display image. The at least one display image includes a first image element for, in a first mode of operation, initiating execution of the parent medical information system application and enabling access to the plurality of data items in the repository. The display window further includes a second image element for, in a second mode of operation, initiating execution of a child medical information system application for processing a second set of clinical data items employing a second different set of codes, terms and identifiers. A mapping processor adaptively switches from using the first set of codes terms and identifiers in the first mode to using of the second set of codes, terms and identifiers in the second mode and employs a map associating the first set of codes, terms and identifiers with the second set of codes, terms and identifiers in response to configuration data enabling the child medical system application to access data stored in the repository, in response to user selection of the second image element. A data interface is conditioned for using said map in automatically transferring a value of a selected individual data item from said repository to a data field employed by said child medical information system application when operating in said second mode for outputting medical report data.

### CROSS REFERENCE TO RELATED APPLICATIONS

This is a non-provisional application of provisional application Ser. No. 61/102,200 by A. Belden et al. filed Oct. 2, 2008.

### FIELD OF THE INVENTION

This invention concerns a system for providing medical data, for example, that operates in at least two modes for mapping data between a source system and a destination system.

### BACKGROUND OF THE INVENTION

Medical information systems often create identifiers of a certain type and receive identifiers of other types from other systems. For example, a Radiology Information System (RIS) creates identifiers e.g. an Accession Number, for procedures that are ordered. A RIS usually receives patient and order identifiers from a Hospital Information System (HIS). A situation may arise in which two RIS products at a site exchange data and one of the products employs pointers in its database to procedures created in the other product. This situation may only be temporary while one product is being migrated to the other. Further, if there are identifier conflicts or incompatibilities arising when data of one information system is added to a database of another existing system, typically new non-conflicting identifiers are created in a receiving system. However, this frequently causes a loss of referential integrity to other data repositories in a healthcare enterprise. Therefore integration of a RIS with a different system such as a picture archiving and communication system (PACS) may be limited requiring user manual intervention to access and view images of a particular patient, for example. If two known medical information systems of the same type operate in a hospital, for example, they typically identify patients, orders and procedures in an independent fashion. This presents a problem particularly for multi-site healthcare networks and impedes seamless integration and interoperability between systems.

Known data exchange systems typically employ customized software to ensure compatibility of identifiers with a different system e.g. a HIS and a RIS, having incompatible formats. However, providing customized software is slow and error-prone and is performed on a site by site basis. Communication standards such as HL7 (HealthLevel7) and DICOM (Digital Imaging and Communications in Medicine) facilitate interoperability to a degree but problems arising from identifier incompatibility and conflict remain.

Known interface engines typically do not store the data of information systems but just an indication of the format or arrangement of data for a given transaction type and do not maintain identifier data and keep it synchronized with multiple information systems and are typically incapable of mapping identifiers between different computer systems. Such interface engines typically just map data fields from one place in a transaction to another and a destination computer system is unaware of source system identifiers and cannot address identifier conflict and incompatibility. Known data exchange systems lose referential integrity in exchanging data including identifiers between different information systems in a healthcare enterprise and fail to provide comprehensive integration between information systems of the same type. Such known systems also typically involve long lead times for installation of systems from different vendors due to the need for customization and substantial on-site testing. A system according to invention principles addresses these deficiencies and related problems.

### SUMMARY OF THE INVENTION

A multi-mode system and method for exchanging patient medical record information and data representing an order for a medical procedure for a patient between different medical information systems for producing medical report data is provided. The system comprises a repository including a first set of clinical data items employing a first set of codes, terms and identifiers associated with a plurality of different patients accessible by a parent medical information system application. A user interface initiates generation of data representing at least one display image. The at least one display image includes a first image element for, in a first mode of operation, initiating execution of the parent medical information system application and enabling access to the plurality of data items in the repository. The display window further includes a second image element for, in a second mode of operation, initiating execution of a child medical information system application for processing a second set of clinical data items employing a second different set of codes, terms and identifiers. A mapping processor adaptively switches from using the first set of codes terms and identifiers in the first mode to using of the second set of codes, terms and identifiers in the second mode and employs a map associating the first set of codes, terms and identifiers with the second set of codes, terms and identifiers in response to configuration data enabling the child medical system application to access data stored in the repository, in response to user selection of the second image element. A data interface is conditioned for using said map in automatically transferring a value of a selected individual data item from said repository to a data field employed by said child medical information system application when operating in said second mode for outputting medical report data.

### BRIEF DESCRIPTION OF THE DRAWING FIGURES

FIG. 1 is a block diagram illustrating the mapping performed by the system according to invention principles;

FIG. 2 illustrates an exemplary map record employed by the mapping layer according to invention principles;

FIG. 3 is a block diagram detailing exemplary workflow employed the system according to invention principles;

FIG. 4 is a block diagram of the system according to invention principles; and

FIG. 5 is an exemplary screen shot of the system according to invention principles.

### DETAILED DESCRIPTION OF THE INVENTION

A system according to invention principles receives standards-based or proprietary transactions from a medical information system application and maps a patient, order and procedure identifiers in the transaction to be compatible with a destination system database, regardless of differences in formats used by the respective systems and/or applications and regardless of whether the receiving system is usually the creator or source of such identifiers. In one embodiment, the system enables a user using a first medical information system application (parent application) that communicates and pulls data from a repository using a first set of codes, terms and identifiers to take advantage of the functions of a second different medical information system application (child application) which employs a second different set of codes, terms and identifiers that are incompatible with the first set. The parent and child applications may have similar or different functions in order to produce medical report data for a user. The inventors realize that it is desirable to integrated different vendor systems and applications without requiring the back-end coding and setup typically associated with the installation of a new and different medical information system and/or application. The mapping capability of the system advantageously enables a child application to acquire and provide data to a user in a user interface using data from a repository that is structured for use with the parent application. The child application is thus advantageously able to compatibly communicate with the parent application using standards-based or proprietary transactions associated with the parent application. The system eliminates the limitation of having only a single medical information system with its own suite of applications of a given type active at a given site within a healthcare enterprise. The system advantageously integrates two or more medical information systems and their applications and addresses the problem of conflict and incompatibility (e.g. in format) between identifiers used by different medical information systems and the need to merge such identifiers.

As used herein, a Medical Information System (MIS) is a suite of executable applications that stores and manipulates patient medical data and supports functions applicable in the particular medical domain. For example, a Radiological Information System stores patient, procedure and various other kinds of data and supports functions such as diagnostic reporting and tracking of procedures. Other examples are a Hospital Information System (HIS), a Laboratory Information System (LIS), a Clinical Information System and a Cardiology Information System (CIS). Respective medical information systems and applications employ sets of codes, terms and identifiers. Terms are words or phrases used in a healthcare context. A medical code set as used herein is any set of codes used for encoding data elements, such as tables of terms, medical concepts, medical diagnosis codes, or medical procedure codes. Code sets and identifiers 411 and 415 include HIPAA (Health Information Portability and Accountability Act) compatible code sets and other code sets used in a health care operation. Such code sets include, for example, ICD (International Classification of Diseases) codes, 9th Edition, Clinical Modification, (ICD-9-CM), Volumes 1, 2 and 3, as well as ICD-10 maintained and distributed by the U.S. Health and Human Services department. The code sets also include code sets compatible with HCPCS (Health Care Financing Administration Common Procedure Coding System), NDC (National Drug Codes), CPT-4 (Current Procedural Terminology), Fourth Edition CDPN (Code on Dental Procedures and Nomenclature). Further the code sets and terms include code sets compatible with SNOMED-RT “Systematicized Nomenclature of Medicine, Reference Terminology” by the College of American Pathologists, UMLS (Unified Medical Language System), by the National Library of Medicine, LOINC Logical Observation Identifiers, Names, and Codes Regenstrief Institute and the Logical Observation Identifiers Names and Codes (LOINC®) Committee, Clinical Terms also known as “Read Codes”, DIN Drug Identification Numbers, Reimbursement Classifications including DRGs Diagnosis Related Groups. The code sets also include code sets compatible with CDT Current Dental Terminology, NIC (Nursing intervention codes) and other code sets used in healthcare.

Identifiers are data items that identify patients, orders, medical procedures, etc in the healthcare domain. Examples include, but are not limited to, patient name, patient medical record number, order number and Accession Number. Respective applications of various medical information systems employ application programming interfaces (API). An API is the programmatic public face of a piece of software that allows applications using the software to invoke its various functional capabilities. Medical information systems also employ different data standards for communicating among and between devices. An exemplary format is the Digital Imaging and Communication in Medicine (DICOM) which is a medical informatics standard. A further example is Health Level 7 (HL7) which is also a medical informatics standard. Medical information systems are able to communicate and interact with Picture Archiving and Communication System (PACS) which is a set of applications that store and display medical images and related data in a particular format. A transaction data is a standards-based or proprietary transaction stream that is communicated across a network between conforming applications. A data interface engine is a device for processing and understanding various types of health informatics standards e.g. DICOM, HL7, and supports functions such as the ability to map fields from one position in a transaction to another and the ability to route transactions to multiple destinations.

A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a controller or microprocessor, for example, and is conditioned using executable instructions to perform special purpose functions not performed by a general purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a user interface processor and enabling user interaction with a processor or other device and associated data acquisition and processing functions.

The UI also includes an executable procedure or executable application. The executable procedure or executable application conditions the user interface processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

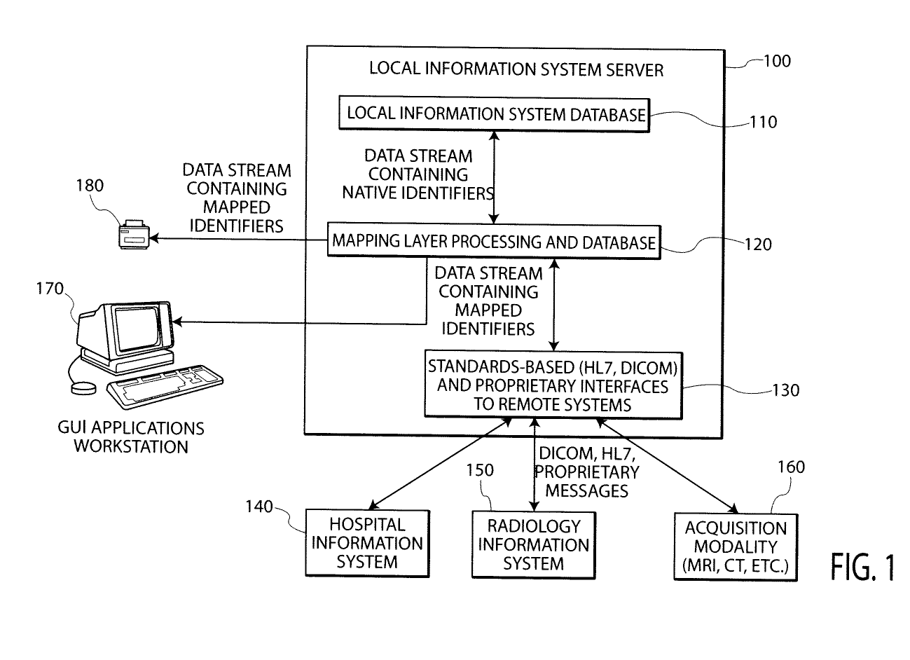

An exemplary multi-mode medical data exchange and report system is illustrated in FIG. 1. In this embodiment, the system includes a medical information system server 100. The server 100 includes a repository (database) that stores patient medical data and order information in a first data format that is accessible by a particular medical information system application, for example, an RIS application 150. System 100 includes a communication interface 130 that facilitates communication between the system 100 and a plurality of remote medical information systems that have at least one MIS application associated therewith. For example, communication between the system 100 any of the Hospital Information System (HIS) 140, Radiology Information System (RIS) 150, and an image acquisition modality (e.g. MRI, CT, etc) device 160 is facilitated by the communication interface 130 in a known manner.

A mapping layer 120 is a specific purpose processor and is provided to receive, interpret and store application-specific sets of codes, terms and identifiers. The mapping layer 120 utilizes at least one set of configuration data that is associated with a particular MIS application for use in creating map data enabling adaptive functional mapping of a set of codes, terms and identifiers for a first (parent) MIS application to a second different set of codes, terms and identifiers associated with a second (child) MIS application. Configuration data may be predetermined, for example, provided by a vendor to enable full or limited access to the features of the MIS application. Alternatively, the configuration data may be specified in response to user input whereby the user manually specifies the set of codes, terms and identifiers to be associated and used with the particular MIS application. For example, the user at the site where the application will be used can specify within the configuration data a particular sub-set of codes, terms and identifiers to be mapped between applications.

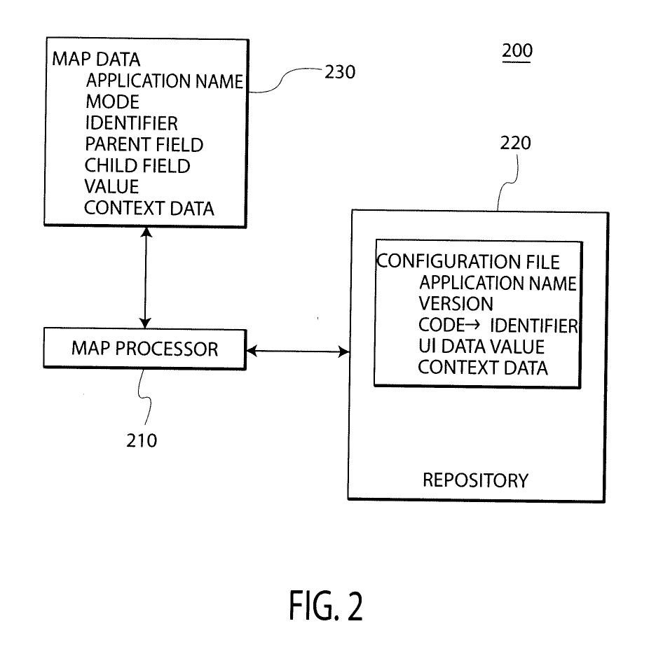

The mapping layer 120 uses the configuration data to generate map data that is used for mapping the native functions of the child MIS application to the parent MIS application. The map data is used by mapping layer 120 to allow the functions associated with the child MIS application to process and use data stored in the database of the server 110 that is structured for use by the parent MIS application as discussed with respect to FIG. 2. Thus, the system 100 advantageously employs the mapping layer 120 and map data to enable a user to take advantage of the functions of an MIS application that previously would have required either installation of a new MIS system or significant coding modification of the child MIS application to work with the parent MIS application.

In exemplary operation, the system 100 enables medical information systems to operate in side-by-side mode with a bidirectional interface between them. The system 100 provides multi-mode simultaneous operation of two different MIS applications of the same type that each have their own set of codes, terms and identifiers that conflict or are incompatible with one another. The exemplary operation described herein details applications associated with two different Radiology Information Systems 150. However, one skilled in the art will recognize that the function and operation described herein is applicable to applications employed by two different Hospital Information Systems 140 or any other information systems deployed throughout a healthcare enterprise.

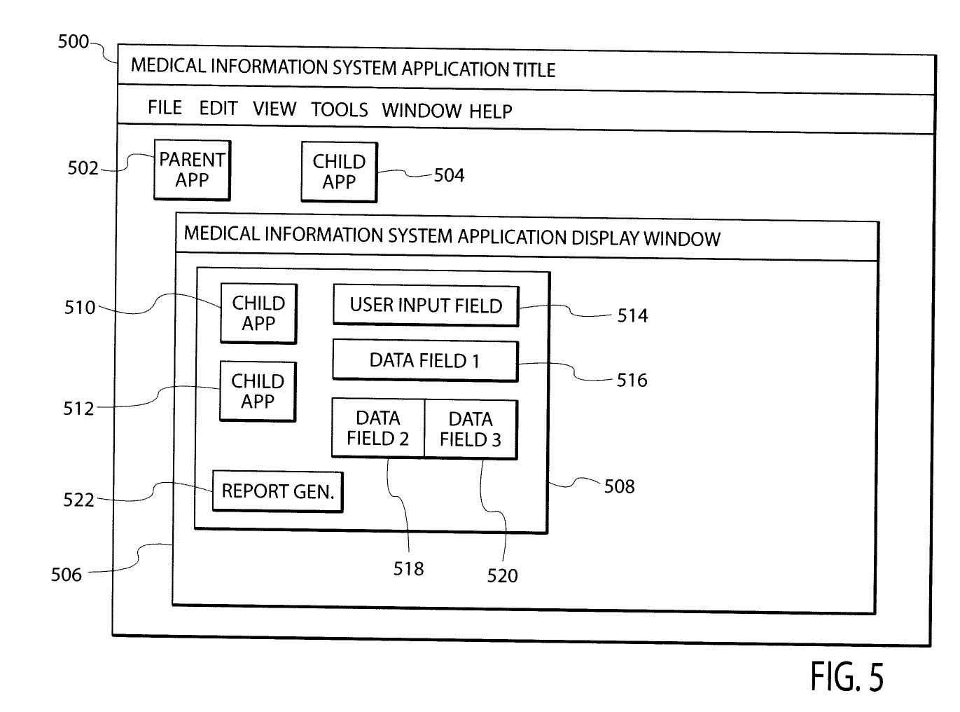

The system 100 enables a user at workstation 170 to access and use a parent RIS application. The user uses the parent RIS application to access, retrieve and manipulate patient medical data that is stored in the database of server 110 because the database is accessible by the parent RIS application. The user, in this first mode of operation, uses the native functions of the parent RIS application to interrogate the database of server 110 to compile and generate at least a portion of a medical report for a particular patient which may be output at a printer 180, for example. The inventors recognize that the parent RIS application may not provide the user with a particular function that is needed by the user to produce the requested medical report. System 100 advantageously enables the user to make use of capabilities or applications of a secondary (child) Radiology Information System that the first lacks. In this instance, the user at workstation 170 selects an image element on a display screen (FIG. 5) that initiates operation of system 100 in the second mode. In the second mode of operation, the user is able to utilize any function of the child RIS application to acquire and provide patient medical data and/or medical order information from the database of the server 110. Upon initiation of the desired function of the child RIS, the mapping layer 120 automatically maps the codes, terms and identifiers associated with the child RIS application to the corresponding codes, terms and identifiers used by the parent RIS application for accessing the database 110 using the configuration data associated with the child RIS. Once mapped, the system 100 adaptively switches between the first and second set of codes, terms and identifiers enabling the user to interrogate the database using the child RIS functionality without fundamentally altering the code of the child RIS application. This enables the user at workstation 170 to produce a medical report using two different and incompatible RIS applications. This advantageously provides a doctor with a more comprehensive medical report and provides a clearer picture of the health of the patient while reducing time and cost of deploying two disparate information systems.

In another embodiment, for example, in multi-hospital or multi-site configurations where the records of one information system are desirably integrated into another existing (successor) system, there is a likelihood of collisions with identifiers of the two systems. The system supports a seamless integration of the data of the two systems with no loss of data or function. This extends to integration with other information systems which may have embedded references to the identifiers of a predecessor system. For example, a PACS holds thousands or millions of images referencing patient and procedure identifiers created by an initial system. It may not be practical to convert the PACS database to reference new identifiers created by a successor system. Therefore the system is used by the successor system to be able to make use of the identifiers of the predecessor system to retain access to data in the PACS.

In another embodiment the map processor 120 of system 100 is implemented as part of an interface engine. An interface engine is a network node that receives transactions, reconfigure them and route them to the desired destination system. The interface engine supports a remote procedure calling interface for information systems to be able to create the mapped identifiers on demand and store them as map data 110 in a repository. The system is usable within health informatics for mapping of standardized code sets to proprietary or other standardized code sets. For example, medical image creating devices such as a CT scanner frequently uses a proprietary coding scheme to specify its procedures. When these codes are transmitted to other systems in various transactions, a mapping between the originating system's codes and those of the receiving system is used to automate billing and supply ordering, for example. The system advantageously maps local and remote identifiers and uses the mapped identifiers in communications with a remote system and in a local system's UI as well as in printed documents. The system advantageously enables use of identifiers of the parent system when communicating with systems other than the parent system without needed to modify the code or structure of the other systems.

FIG. 2 is a block diagram of an exemplary system 200 according to invention principles. System 200 includes a map processor 210 that enables interoperation of medical information systems when, for example, the format of identifiers of the same type are not the same in the two systems. This is done without the need for site-by-site customization of either information system's software. For example, the HIS may create alphanumeric patient identifiers while the RIS only supports numeric patient identifiers. Alternatively, the HIS and the RIS may require the identifiers be different lengths. The system 200 enables interoperation of a UI of the receiving system in the sense that the identifiers of the source system can be displayed in this UI despite differences in format and length. In order to ensure compatibility, the receiving system makes use of its own native codes, terms and identifiers to processing application functions. However, the map processor 210 facilitates the mapping between the codes terms and identifiers of the receiving system and those used by a source system. Thus, the receiving system is configured to display the source identifiers in its UI. The receiving system does this by dynamically setting (if needed) attributes (i.e. length, datatype, etc) of the UI element that will display a given identifier, based on data in the mapping tables or files. In the event that a given identifier cannot be fully displayed in the UI of the receiving system due to layout of a given form, an alternate display mechanism is provided. For example, a tool tip will hold the full value and will display when a mouse is moved over the UI element. The system improves clinical outcomes by providing referential integrity across different medical information systems, lower lead times to integrate systems; and lower support costs due to less customization of code.

The system 200 employs a mapping processor 210 between the codes, terms and identifiers of a parent MIS application (or system) and those of a child MIS application (or system). The system supports mapping with multiple remote systems. Each respective MIS connected to system 200 includes a configuration data file or relational table 220 associated therewith. The configuration data file 220 includes a configuration entry for each parent application (or system). The configuration entry includes, for example, the name of the parent application (or system), a coded list of identifiers being mapped between the parent application (or system) and the child application (or system), a format of each identifier (i.e. data type and maximum length) and a list of inbound and outbound transactions that are need to reflect the mapping, for example, standards-based transactions such as HL7, DICOM, that would represent communications between a parent and child application (or system. The mapping processor 210 parses the configuration data file 220 to generate the map data 230.

System 200 enables mapping between at least one of (a) a parent MIS system and a child MIS system, (b) a parent MIS application and a child MIS application, and (c) a combination thereof. The elements included in map data necessary to map between systems versus applications is different. In an embodiment for mapping between parent MIS systems and child MIS systems, the map data includes, for example, the following attributes:

Remote (parent) System Name

### Identifier Name or Tag

Remote (parent) Value
Local (child)Value

### Mode

The identifier is a value describing the feature(s) being mapped between the parent and child MIS systems. The remote value is data used by the parent MIS system and the local value corresponds to equivalent data used by the child MIS. The Mode identifier is a value used by the map processor 210 to instruct the system that the mapping taking place is between MIS systems or between applications employed by at least two MIS systems. For example, the Mode value is queried by the map processor 210 to determine the type of map data 230 needed for performing the desired mapping.

In this embodiment, the map processor 210 adds a mapping given a parent system name, an identifier name and a local value. Mappings are added when certain transactions are passed from the parent to the child system based on entries in the configuration data file 220. For example, patient registration messages from a parent RIS to child RIS enables creation of a mapping entry by the map processor 210 in map data 230 that maintains a format of a particular data value. The received patient medical record number employed by the parent RIS includes leading zeroes, (e.g., 000000649273), and the child medical record number truncates the leading zeros, (649273). If there are later communications sent from child RIS to parent RIS, such as order status updates or new orders, the medical record number is sent in the format used by the parent RIS. The ability to communicate with a system using identifiers in preferred formats facilitates interoperability between different medical information systems of the same type which use different codes, terms and identifiers for related functions.

Additionally, the map processor 210 performs a mapping given the parameters above and thereby extends the functionality of the child system to the users of the parent system. For example, when the child RIS needs to send a diagnostic report to the parent RIS using an HL7 ORU (Observational Report—unsolicited) message, the map processor 210 queries the configuration data file 220 to determine what identifier mapping is associated with the parent RIS. If the child RIS has an Accession Number mapping specified to the parent RIS, the child RIS will insert the mapped Accession Number of the parent RIS into the transaction. This mapping ability enables the child RIS to act as an adjunct to the parent RIS by creating reports that are stored in a repository of the parent RIS and which are viewable using via the user interface of the parent RIS.

The map processor 210 also enables deletion of a particular mapping from map data 230. For example, individual patients are sometimes erroneously registered with multiple medical record numbers. To rectify matters patient merge transactions are created on a parent information system and sent to other child departmental systems. If a child system is mapping patient identifiers to the parent system, the map processor will delete a mapping entry for the merged-from identifier when it receives the patient merge transaction, e.g. HL7 A40. This ability to deleting obsolete mappings promotes referential integrity across different medical information systems within a healthcare enterprise.

An exemplary mapping process employed by map processor 210 that facilitates mapping between two medical information systems of the same type, i.e. RIS—RIS mapping, is as follows. Configuration data associated with the parent RIS is created by information system administrators specifying that the child RIS will map the Accession Numbers created by the child RIS locally to the Accession Numbers created in parent RIS a. The configuration data further indicates that HL7 ORM transactions from the parent RIS will carry new Accession Numbers from the parent RIS that must be mapped and that any outbound HL7 ORM (General Order Message) and ORU (Observational Report—Unsolicited) to the parent RIS should include the mapped to Accession Numbers. An ORM is received from the parent RIS that indicates a new procedure is scheduled to be performed. The child RIS interrogates, via the map processor 210, the map data 230 to identify the mapping configuration and determine that a mapping needs to be created from the parent RIS Accession Number to a the Accession Number created by the child RIS. The parent RIS creates the new Accession Number and provides it, along with the child RIS Accession Number and data representing the name of the child system to the map processor 210 for creating map data 230 including these values. In the instance that the procedure referenced in the ORM is reported using the child RIS, the child RIS sends the report which has been signed by the proper personnel to the parent RIS in an HL7 ORU message. When the child RIS is ready to send the ORU to the parent RIS, the map processor 210 parses the map data 230 to determine a mapping configuration for mapping identifiers to the parent RIS. The map processor 210 determines that a mapping path exists between the parent and child RIS's for Accession Numbers used by the respective systems. The map processor 210 enables the child RIS to interrogate the map data 230 and retrieve data representing the Accession Number associated with the parent RIS. This value is included the ORU transaction sent by the child RIS to the parent RIS.

A mapping is not necessary in certain cases. For example when the information systems are not of the same type e.g. HIS and RIS, the destination system may be able to use the source system's identifiers as keys within its own database or the identifiers of the destination system are used within the local system's database. This is not likely to work if the information systems are of the same type e.g. RIS and RIS. One reason that a mapping may be required is because of conflict or incompatibility. Another reason is that information systems differ in the way they create identifiers of the same type as discussed above. The map processor 210 allows a system to use its own identifiers internally and use the identifiers of the child system when communicating with that system or when displaying the identifiers of the child system in a UI.

In another embodiment, system 200 facilitates mapping between respective applications of different medical information systems. In this embodiment, the map data 230 created by the map processor 210 includes additional data values representing attributes associated with particular application functions in the map data 230. Additionally, the map data 230 includes data representing procedure identifiers that identify executable procedures to be used by child medical information system application to access the data in a repository of a parent medical information system application. Mapping between applications of different system enables a user of the parent system to harness the functionality of the child system without requiring a full installation of the child MIS or significantly altering the code of the child MIS application. Because the child MIS application is configured to access and process data in a manner different from the parent MIS and uses codes, terms and identifiers different from the parent MIS application, the map data 230 includes values able to facilitate interoperation of the different applications. An example of map data 230 used to map between applications of a parent MIS and a child MIS is:

Remote (parent) System Name

### Parent Attribute Name

### Child Attribute Name

### Mode

The Parent Attribute Name is the name of a given attribute in the master database. The Child Attribute Name is the name of the variable in the child application that corresponds to the attribute in the master database. For example, in the child application, the medical record number may be referred to as MedRecNo whereas in the parent database the same data is referenced as med_rec_no. The map data enables the child application set up the mapping between the two so that when the user executes a function within the child application, the child application fetches data from the parent database and associate the data returned from the parent's database with the native internal variables of the child application. There is additional configuration of sql stored procedures used for performing specific operations stored in the configuration data file. For example, one stored procedure could be configured to fetch a list of patients, another to fetch a list of procedures for the patient, etc. These could be furnished by the vendor of the parent system, written onsite, etc. When the Child application calls one of these stored procedures, it uses the map above to associate the data that has been retrieved to variables within itself. The Mode identifier is a value used by the map processor 210 to instruct the system that the mapping taking place is between MIS systems or between applications employed by at least two MIS systems. For example, the Mode value is queried by the map processor 210 to determine the type of map data 230 needed for performing the desired mapping. The program attribute value includes data representing a function of the child MIS application to be used by the parent MIS application.

When mapping systems in their entirety, each respective system includes its at least one native application and repository for storing data using and therefore only codes terms and identifiers are mapped because each respective system operates independently. Thus, the map bridges conflicting and/or different codes, terms and identifiers between systems. In contrast, mapping applications of different systems includes additional attributes in the map data record because only the application function and interface of the child MIS application are deployed. When mapping the functionality of a child MIS application for use by a parent MIS application, map data includes references to the procedures of the parent MIS application which are used by the child MIS application to access and act upon data in the repository of the parent MIS.

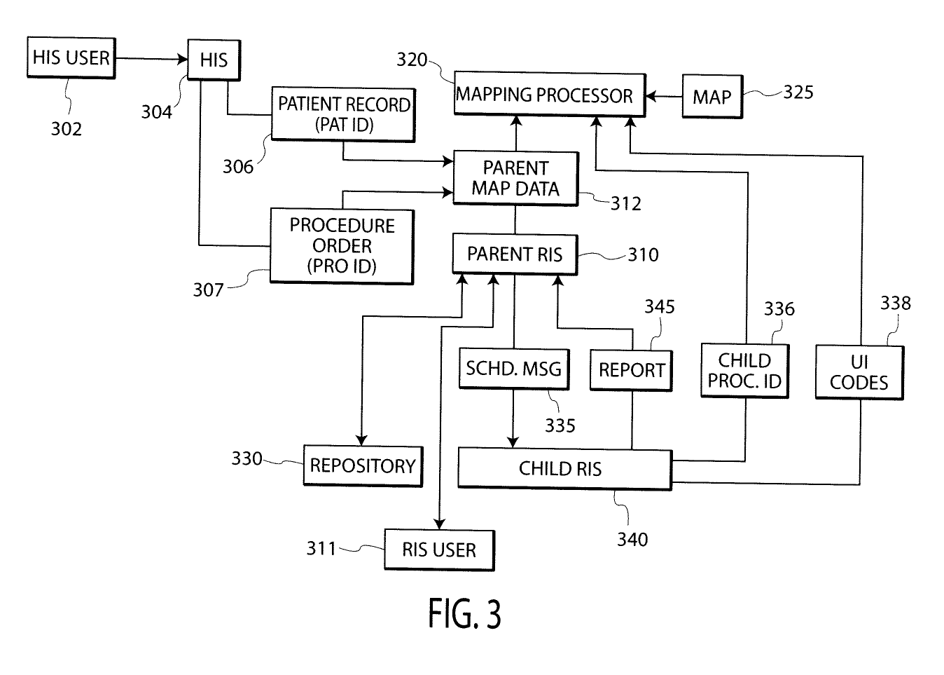

Another exemplary sequence of events demonstrating the use of the mapping processor 210 (FIG. 2) is provided in FIG. 3. A HIS user 302 connected to HIS 304 creates a patient record registration 306 within the HIS for patient Ralph Smith having medical record number 14A. HIS 304 is connected to parent RIS 310 and communicates patient record 306 (with the unique medical record identifier) to the RIS 310. An HL7 admission, discharge, transfer (ADT) transaction is sent from HIS 304 to RIS 310 which adds one or more records to the RIS database for Ralph Smith. Parent RIS forwards the ADT message to child RIS 340. However, child RIS 340 does not support alphanumeric medical record numbers but instead uses numerical identifiers. Child RIS 340 uses the map processor 320 layer to create and store a mapping from the internal medical record number created by child RIS 340 for patient Ralph Smith (medical record 212). Map processor 320 creates a map 325 that maps numerical identifier 212 of the child RIS 340 to the alphanumerical identifier 14A used by the parent RIS 310.

In another example, the HIS user 302 creates an order 307 for Ralph Smith for a Computed Tomography (CT) scan of the abdomen using HIS 304. HIS 304 communicates the order 307 via an HL7 ORM message to the parent RIS 310. Upon receipt, parent RIS 310 creates a procedure for the order in its database with Accession Number 202. The parent RIS 310 sends an HL7 ORM Procedure Scheduled message 335 to the child RIS 340 containing Accession Number 202 used by the parent RIS 310. The child RIS 340 when operating in its native mode and, in response to receiving ORM messages, automatically creates a child procedure ID 336 which is a specifically formatted Accession Number and provides the child procedure ID 336 to the map processor 320 for use in creating or appending map data 325. The map data is updated to map the child procedure ID value to the parent procedure ID value 307 for the purposes of enabling communication between the child RIS 340 and parent RIS 310 rather than modify the code of the child RIS 340 that automatically creates its own Accession Numbers.

Once the procedure is completed and medical image data acquired by the CT scan is stored in a repository 330 of the parent RIS 310, RIS user 311 may prefer a reporting package associated with the child RIS 340 and elect to use the reporting application of the child RIS 340 to create the diagnostic report for Ralph Smith's CT. The RIS user 311 accesses the parent RIS 310 operating the parent RIS application in a first mode of operation and directly accesses the medical image data of patient Ralph Smith using the parent RIS 310. While operating in the first mode, the RIS user 311 can selectively launch the reporting application of the child RIS 340 from within an application of the parent RIS 310 causing the system to operate in a second mode. Once launched, data representing UI code 338 of the reporting application of the child RIS 340 is provided to the map processor 320 to fetch the mapped patient and procedure identifiers, if they exist. The map processor 320 uses the map 325 to acquire the mapped identifiers for display as a report 345 in the child RIS 340 UI as these are the original identifiers in this case and to avoid confusion for the users. Similarly, in a printed report, the identifiers of the originating system are used.

After the report 345 is completed and signed, child RIS 340 creates an HL7 ORU message to send to parent RIS 310 containing the signed report. Child RIS 340 connects to the map processor 320 to fetch the mapped Accession Number for 4995 (202) and the mapped Medical Record Number for 212 (14A). It builds the ORU message using these identifiers and sends it to the parent RIS 310. This enables the parent RIS to display the report 345 created by child RIS 340 using the native identifiers of the parent RIS 310. The workflow described in FIG. 3 is provided as an example and one skilled in the art would readily recognize many possible variations to the workflow including different communication paths as well as the incorporation of additional information systems typically used within a healthcare enterprise.

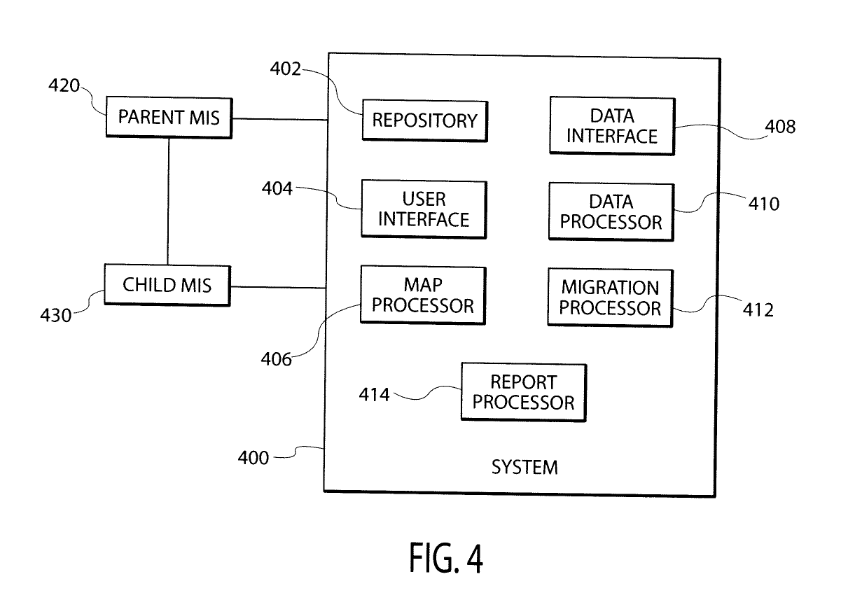

A block diagram of an embodiment of the multi-mode medical reporting system 400 is provided in FIG. 4. The system 400 comprises a repository 402 including a first set of clinical data items employing a first set of codes, terms and identifiers associated with a plurality of different patients accessible by a parent medical information system application 420. A user interface 404 is provided and initiates generation of data representing at least one display image as shown in FIG. 5. The display image includes a first image element for, in a first mode of operation, initiating execution of the parent medical information system application and enables access to the plurality of data items in the repository. The display image further includes a second image element for, in a second mode of operation, initiating execution of a child medical information system application 430 for processing a second set of clinical data items employing a second different set of codes, terms and identifiers. The user interface advantageously maintains the second image element within the at least one display window during operation in the first mode allowing the user to select the second image elements to launch the child medical information system application from within the parent medical information system application. This is particularly useful when creating a comprehensive medical report including data requiring different views of a particular set of data (e.g. CT scans) that may require using both the parent and child applications to obtain the desired views, for example. 13. The set of codes, terms and identifiers includes application context information associated with a type of data being requested by the medical information system application. For example, the application context information includes information associated with at least one of (a) a type of medical examination (b) a type of medical image data, (c) a format of medical image data, (d) patient history, (e) a type of patient parameter, (f) a type of device for acquiring patient data, (g) report structure format for use in reporting medical observations and (h) clinical data associated with a particular patient. This context information may be provided by the user via the user interface 404 or selected from a list of candidate application context information provide when the user is selecting data items of interest from within the parent MIS application 420 or child MIS application 430.

A mapping processor 406 adaptively switches from using of the first set of codes terms and identifiers in the first mode to using the second set of codes, terms and identifiers in the second mode. The mapping processor 406 employs a map (FIG. 2) associating the first set of codes, terms and identifiers with the second set of codes, terms and identifiers in response to configuration data enabling the child medical system application 430 to access data stored in the repository 402, in response to user selection of the second image element. The configuration data used by the mapping processor 406 is predetermined configuration data associated with the parent medical information system application and stored in the repository 402. The configuration data is automatically updated by the mapping processor 406 in response to selection of an individual data item when operating in the second mode. This facilitates a quicker mapping between the parent and child applications and also provides a more comprehensive map for use by either the parent or child applications when communicating between them. Alternatively, the configuration data includes user interface (UI) configuration data for configuring a display format of data items and data fields within the user interface 404 when operating in the first mode. When the configuration data include UI configuration data, the user interface 404 is able to modify a user interface display format associated with the child medical information system application 430 to mirror a user interface display format associated with the parent medical information system application 420.

An exemplary set of map data used for mapping the parent and child medical information systems is described in FIG. 2. The map data also may include a mode identifier enabling adaptive switching between the first and second mode of operation in response to user specified context information. 11. The context information is provided during the second mode of operation via the user interface 404 and is at least one of (a) entered by a user and (b) selected from a candidate list of context information displayed within the at least one display window displayed by the UI 404.

A data interface 408 is conditioned for using the map in automatically transferring a value of a selected individual data item from the repository 402 to a data field employed by the child medical information system application 430 when operating in the second mode. This enables the user to create and output medical report data using data typically unavailable to the child medical information system application 430.

The system 400 further includes a data processor 410 which uses the map data to enable use of executable procedures associated with the parent medical information system 420 application by the child medical information system application 430 when the system 400 is operating in the second mode of operation. The data processor 410 automatically provides user credential information enabling access to the repository 402 obtained during the first mode of operation to the child medical information system application 430, in response to selection of the second image elements in the user interface 404.

The also includes a migration processor 412 for use in updating configuration files associated with various medical information system applications in order facilitate more accurate and comprehensive mapping between different MIS applications. The migration processor 412 analyzes a configuration file associated the child medical information system application 430 to identify an updated set of codes, terms and identifiers and automatically adds the identified updated set of codes, terms and identifiers to the second set of codes, terms and identifiers. The updated second set of codes, terms and identifiers is provided to the mapping processor 406 for use in generating map data. The migration processor 412 automatically initiates a search for updated configuration files associated with the child medical information system application 430 at predetermined time intervals. In another embodiment, the migration processor 412 initiates a search of available candidate child medical information system applications 430 within a healthcare enterprise for selection by a user. The available candidate child medical information system applications have a particular set of codes, terms and identifiers associated therewith. Once identified, the migration processor 412 automatically acquires data representing a configuration file including the particular set of codes, terms and identifiers associated with a selected candidate child medical information system application and provides the acquired configuration file data to the mapping processor 406 for use in generating map data mapping said selected candidate child medical information system application to the parent medical information system application 420.

The system 400 also includes a report processor 414 for generating data representing a medical report including data items selected during the first and second mode of operation. The report processor 414 communicates with the mapping processor 406 and maps values associated with the selected data items stored in the repository 402 to data fields within the medical report. The report processor 414 uses the map to adaptively switch between data requested by the parent application 420 and data requested by the child application 430 to produce a composite medical report and store the report in the repository 402. The report processor 414 also uses configuration data when generating the medical report and includes application identifiers identifying a name and version of a medical information system application used to access the repository when producing the medical report. The report processor 414 appends the medical report with the application identifier which advantageously enables a user to identify the medical information system applications used to produce the report. This is particularly advantageous in the event that the report needs to be updated and, the update requires data reporting function associated with an further MIS application other than the parent or child. In this situation, the mapping processor 406 automatically determines which applications were used and readily recalls the map data for use with the further MIS application.

FIG. 5 is exemplary screen shot of a display image 500 generated by the user interface (404, FIG. 4). The display image 500 includes user-selectable image elements 502, 504 enabling a user to launch at least one medical information system application. Image element 502 enables the user to launch the parent MIS application which initiates system operation in the first mode. Image element 504 enables the user to launch the child MIS application which initiates system operation in the second mode and requires mapping between the child MIS application and the parent MIS application. While two image elements 502 and 504 are described herein, it should be noted that any number of user selectable image elements that correspond to any number of MIS applications may be displayed enabling the user to launch the desired MIS application.

As shown herein, image element 502 has been selected by the user which results in the UI generating a parent MIS application display window 506. Parent MIS application display window 506 includes at least one sub-window 508 having a plurality of additional user selectable image elements 510, 512, a user input field 514, and plurality of data fields 516, 518 and 520. This configuration is described for purposes of example only and the parent MIS application display window may include any number of different display elements specific the parent MIS for taking advantage of the functionality of the parent MIS. The user input field 514 and the plurality of data fields 516-520 allow the user to use the functions of the parent MIS application and request and display data from the repository in the particular data field 516-520.

Should the parent MIS application prove to be insufficient for the user's purpose, the user may selectively use reporting (or other) functions of the child application. User selectable image elements 510 and 512 enable the user to launch secondary and tertiary child medical information system applications that use a set of codes, terms and identifiers different than those associated with the parent MIS application. Selection of any of elements 510 or 512 initiate system operation in the second mode whereby the mapping processor adaptively switches from using the first set of codes terms and identifiers in the first mode to using the second set of codes, terms and identifiers in the second mode. The mapping processor 406 employs a map (FIG. 2) associating the first set of codes, terms and identifiers with the second set of codes, terms and identifiers in response to configuration data enabling the child medical system application to access data stored in the repository (402, FIG. 4). Upon selection, UI may generate a further display window which includes display elements enabling the user to take advantage of the functions associated with the child MIS application in order to generate medical report data using data from the repository but processed and/or manipulated by the child MIS application. Once processed and/or manipulated, the mapping processor maps the selected data items to a particular data field 516-520. By mapping the data to a data field in the parent application display window, the user is not forced to learn an entirely new application layout and increases the efficiency with which the user is able to create a medical report. Moreover, the report is more comprehensive because there are more tools and functions made available to the user without the typical expense of setting up multiple different information systems within a single healthcare enterprise.

The system described above with respect to FIGS. 1-5 is a set of health information system applications, for example parent and child applications, that each supports different modes. In one mode, a given application is able to access and use information from a master database for display within its native user interface. In this mode, the same set of codes, terms and identifiers are used for access and display of selected data items. In a second mode, a child application can be configured such that the data used to populate its UI can be wholly or partially drawn from the master database. Data fields in the child application are mapped to fields in the master database as described in FIGS. 2 and 4, for example. Access to the master database is provided via ODBC and uses stored sql procedures. The names of the stored procedures that are used by the child application to access the master database are read from configuration files and may be supplied by the vendor of the parent or child applications, for example. In the event there are data fields that the child application uses which are not present in the master database, then these fields can be configured to not be displayed or used or child can populate a secondary database with these additional fields. In the latter case, the fields could be entered in the UI of the child application and saved to the secondary database. Moreover, the UI elements of the child application resemble those of the parent application (e.g. color, shape and font of UI elements). The child application is driven from a worklist UI element that can be embedded within the UI of the parent application or be displayed separately on the desktop. This worklist element populates itself by interrogating the master's database. The child application uses the mapping of its codes, terms and identifiers to those of the parent application and sql procedures supplied by the parent application or written by onsite staff to fetch a worklist of items it can perform. Each item on the worklist contains the information needed by the child application to perform the task related to that item. Use of worklists to drive application workflow is a very common idiom in the world of health information systems. Using this method makes the transition from parent to child application very seamless. Additionally, as access to healthcare data requires compliance with certain laws, security is paramount. Therefore, the system enables a user's security credentials entered when accessing the parent application to be passed to the child via a Microsoft COM or file-based mechanism.

The advantages of the multi-mode reporting system are further realized when a radiologist reports procedures of various modalities e.g. CT, MRI, etc., within the UI of a reporting application that is part of the Radiology Information System installed at a given hospital. A separate reporting application supporting the multi-modes operation described above is more optimal for reporting Ultrasound procedures because it supports display and incorporation of DICOM Structured Reports which are created by various Ultrasound devices to specify important fetal measurements. On-site personnel have configured the worklist UI element of the child application to pull a list of Ultrasound procedures that are to be reported from the master's database using sql stored procedures. The radiologist logs into the parent application which automatically passes validated user information to the child application via COM or a file-based mechanism. As the parent application displays, the worklist UI element of the child application also displays either within the UI of the parent application or separately on the desktop of the reporting workstation. When the radiologist clicks on an item in the child worklist, the child application UI is initiated and displays data such as patient, order and procedure identifiers pulled from the master database. The radiologist queries the local PACS archive for DICOM Structured Reports related to the procedure being reported. Any reports returned from the query are displayed and may be used by the radiologist as he creates his diagnostic interpretation. The finished report is saved to the master database and the applicable item is removed from the worklist. The radiologist may select another item in the child worklist to report or return to the parent application to report other procedures.

The system and processes of FIGS. 1-5 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, the processes and applications may, in alternative embodiments, be located on one or more (e.g., distributed) processing devices on the network of FIG. 1. Any of the functions and steps provided in FIGS. 1-5 may be implemented in hardware, software or a combination of both.

What is claimed is:

1. A multi-mode system for exchanging patient medical record information and data representing an order for a medical procedure for a patient between different medical information systems for producing medical report data, comprising:
a repository including a first set of clinical data items employing a first set of codes, terms and identifiers associated with a plurality of different patients accessible by a parent medical information system application;
a user interface for initiating generation of data representing at least one display image including,
a first image element for, in a first mode of operation, for initiating execution of said parent medical information system application and enabling access to said first set of clinical data items in said repository, and
a second image element for, in a second mode of operation, initiating execution of a child medical information system application for processing a second set of clinical data items employing a second different set of codes, terms and identifiers;
a mapping processor for adaptively switching from use of the first set of codes terms and identifiers in said first mode to use of the second set of codes, terms and identifiers in said second mode and employing a map associating said first set of codes, terms and identifiers with said second set of codes, terms and identifiers in response to configuration data enabling said child medical system application to access data stored in said repository, in response to user selection of said second image element; and
a data interface conditioned for using said map in automatically transferring a value of a selected individual data item from said repository to a data field employed by said child medical information system application when operating in said second mode for outputting medical report data.

2. The system of claim 1, wherein
said mapping processor uses a predetermined configuration data associated with said parent medical information system application and stored in said repository in generating said map.

3. The system of claim 2, wherein
said mapping processor automatically updates said predetermined configuration data in response to selection of an individual data item when operating in said second mode.

4. The system of claim 1, wherein
said user interface maintains said second image element within said at least one display window during operation in said first mode, said second image elements enabling a user to launch said child medical information system application from within said parent medical information system application.

5. The system of claim 1, wherein
said configuration data includes user interface configuration data for configuring a display format of data items and data fields within a user interface when operating in said first mode.

6. The system of claim 5, wherein
said user interface uses said user interface configuration data to modify a user interface display format associated with said child medical information system application to mirror a user interface display format associated with said first medical information system application and
said data interface maps values of said selected data items from said repository for use by said second medical information system application.

7. The system of claim 1, further comprising
a data processor for,
in said second mode of operation and in response to said map, enabling use of executable procedures associated with said parent medical information system application by said child medical information system application

8. The system of claim 7, wherein
said data processor automatically provides user credential information enabling access to said repository obtained during said first mode of operation to said child medical information system application, in response to selection of said second image elements.

9. The system of claim 1, further comprising
a migration processor for
analyzing a configuration file associated said child medical information system application to identify an updated set of codes, terms and identifiers and
automatically adding said identified updated set of codes, terms and identifiers to said second set of codes, terms and identifiers, and
providing said updated second set of codes, terms and identifiers for use by said mapping processor in generating map data.

10. The system of claim 9, wherein
said migration processor automatically initiates a search for updated configuration files associated with said child medical information system application at predetermined time intervals.

11. The system of claim 1, further comprising
a migration processor for
initiating a search of available candidate child medical information system applications within a healthcare enterprise for selection by a user, said available candidate child medical information system applications having a particular set of codes, terms and identifiers associated therewith,
automatically acquiring a configuration file including said particular set of codes, terms and identifiers associated with a selected candidate chilled medical information system application, and
providing said acquired configuration file to said mapping processor for generating map data enabling generation of map data mapping said candidate child medical information system application to said parent medical information system application.

12. The system of claim 11, wherein
said map includes a mode identifier enabling adaptive switching between said first and second mode of operation in response to user specified context information.

11. The system of claim 10, wherein
wherein said user specified context information is provided during said second mode of operation and is at least one of (a) entered by a user and (b) selected from a candidate list of context information displayed within said at least one display window.

12. The system of claim 1, wherein
said medical information system application is at least one of (a) a radiology information system application, (b) a hospital information system application, (c) a clinical information system application, (d) a hospital billing system.

13. The system of claim 1, wherein
said set of codes, terms and identifiers includes application context information associated with a type of data being requested by said medical information system application.

14. The system of claim 13, wherein
said application context information includes at information associated with at least one of (a) a type of medical examination (b) a type of medical image data, (c) a format of medical image data, (d) patient history, (e) a type of patient parameter, (f) a type of device for acquiring patient data, (g) report structure format for use in reporting medical observations and (h) clinical data associated with a particular patient.

15. The system of claim 1, further comprising
a report processor for generating data representing a medical report including data items selected during said first and second mode of operation by mapping values associated with said selected data items to data fields within said medical report and storing said report in said repository.

16. The system of claim 15, wherein
said configuration data includes application identifiers identifying a name and version of a medical information system application used to access said repository, and
said report processor appends said medical report with said application identifier enabling a user to identify the medical information system applications used to produce the report.
